(19) United States
(12) Patent Application Publication
(10) Pub. No.: US 2026/0319771 A1
(43) Pub. Date: Oct. 15, 2026

(54) APPLICATION PACKAGING METHOD AND DEVICE, APPARATUS AND STORAGE MEDIUM

(71) Applicant: BOE TECHNOLOGY GROUP CO., LTD., Beijing (CN)

(72) Inventors: Sujia Jiang, Beijing (CN); Zhenyan Zhao, Beijing (CN); Danfeng Zhu, Beijing (CN); Naichuan Chen, Beijing (CN); Hongxiang Shen, Beijing (CN)

(73) Assignee: BOE TECHNOLOGY GROUP CO., LTD., Beijing (CN)

(21) Appl. No.: 19/481,296

(22) PCT Filed: Apr. 16, 2024
(86) PCT No.: PCT/CN2024/087971

§ 371 Date: Nov. 4, 2025

(30) Foreign Application Priority Data
May 31, 2023 (CN) 202310637069.4

(51) Int. Cl. G06F 8/41

(52) U.S. Cl. CPC G06F 8/427

(57) ABSTRACT

An application packaging method and device, an apparatus and a storage medium are provided. The method includes: acquiring a DSL data set for describing an initial configuration information of a target application, the target application including a target application page; parsing the DSL data set to obtain a runnable code project including the initial configuration information, the runnable code project includes a target page code file for rendering the target application page; during parsing the DSL data set, populating DSL page data for describing the target application page in the DSL data set into the target page code file; generating a package of the target application based on the runnable code project, the generated package includes a DSL parsing module configured to: during a running process, parse the DSL page data populated in the target page code file, and render the target application page based on a parsed information.

### CROSS REFERENCE TO RELATED APPLICATION

This application is a National Stage Application of International Application No. PCT/CN 2024/087971, filed on Apr. 16, 2024, entitled “APPLICATION PACKAGING METHOD AND DEVICE, APPARATUS AND STORAGE MEDIUM”, which claims priority to Chinese Patent Application No. 202310637069.4 filed on May 31, 2023, which is incorporated herein by reference in its entirety.

### TECHNICAL FIELD

The present disclosure relates to a technical field of computer applications, in particular to an application packaging method and device, an apparatus and a storage medium.

### BACKGROUND

With the popularization of computer technologies, a user may use services provided by various applications, such as video applications, music applications, social applications, etc.

However, these applications often need to be manually developed by developers throughout the process, and the development efficiency is low.

### SUMMARY

The present disclosure provides an application packaging method and device, an apparatus and a storage medium, so as to solve the deficiencies in related art.

According a first aspect of the embodiments of the present disclosure, there is provided an application packaging method. The method includes: acquiring a domain specific language (DSL) data set for describing an initial configuration information of a target application, the target application including a target application page; parsing the DSL data set to obtain a runnable code project including the initial configuration information, in which the runnable code project includes a target page code file for rendering the target application page; during the parsing of the DSL data set, populating DSL page data for describing the target application page in the DSL data set into the target page code file; and generating a package of the target application based on the runnable code project, in which the generated package includes a DSL parsing module configured to: during a running process, parse the DSL page data populated in the target page code file, and render the target application page based on a parsed information.

Optionally, parsing the DSL page data populated in the target page code file, and rendering the target application page based on a parsed information includes: during the running process, parsing the DSL page data populated in the target page code file, and determining, based on the parsed information, a control in the target application page and an attribute value corresponding to the control; and rendering the target application page based on the determined control and the attribute value corresponding to the control.

Optionally, the generated package is further configured to: during the running process, update the DSL page data populated in the target page code file; and invoke the DSL parsing module to parse the updated DSL page data, and re-render the target application page based on the parsed information.

Optionally, the populating DSL page data for describing the target application page in the DSL data set into the target page code file includes: parsing the DSL page data for describing the target application page in the DSL data set, and creating a page initial code file for the target application page based on a parsing result; and populating the parsed DSL page data into the created page initial code file to obtain the target page code file.

Optionally, the parsing result includes an information for indicating whether the target application page includes a business function module; and the creating a page initial code file for the target application page based on a parsing result includes: in a case of determining that the target application page includes the business function module, creating different page initial code files respectively for the target application page and the business function module based on the parsing result.

Optionally, in the case of determining that the target application page includes the business function module, the populating the parsed DSL page data into the created page initial code file to obtain the target page code file includes: populating DSL business data for describing the business function module in the parsed DSL page data into a page initial code file created for the business function module, so as to obtain a business code file; populating DSL layout data for describing a page layout in the parsed DSL page data into a page initial code file created for the target application page, so as to obtain a layout code file; and determining the obtained business code file and the obtained layout code file as the target page code file.

Optionally, the generating a package of the target application based on the runnable code project includes: providing an editing interface for editing the runnable code project such that the runnable code project is secondarily developed based on a user's operation on the editing interface; and packaging the secondarily developed runnable code project to obtain the package of the target application.

Optionally, the generating a package of the target application based on the runnable code project includes: running the runnable code project to acquire a parameter passing information such that the runnable code project is secondarily developed based on the parameter passing information; and packaging the secondarily developed runnable code project to obtain the package of the target application.

Optionally, the business code file is used for rendering a corresponding business function module; the page layout includes a rendering position of the business function module in the application page; and the layout code file is used for determining the rendering position of the business function module in the target application page; and before packaging the secondarily developed runnable code project, the method further includes: checking, in the target page code file, whether the layout code file includes a rendering position information of the business function module.

Optionally, the initial configuration information includes at least one of a page configuration information, an event binding information, a data binding information, and a component routing information.

Optionally, the method further includes: determining a target running platform for the target application and acquiring an application project template of the target running platform, in which the parsing the DSL data set to obtain a runnable code project including the initial configuration information includes: parsing the DSL data set, and obtain the runnable code project including the initial configuration information based on a parsed information and the acquired application project template.

Optionally, the acquired application project template includes a DSL parsing module configured to: during a running process, parse the DSL page data populated in any page code file, and render a corresponding application page based on the parsed information.

Optionally, the acquiring an application project template of the target running platform includes: acquiring a cross-platform application project template; and configuring the acquired cross-platform application project template as the application project template of the target running platform.

Optionally, the method further includes: configuring a basic information of the target application for the acquired application project template.

Optionally, the basic information includes at least one of a target running platform, an application identification, an application package name, an application version number, an application resource file, an application component information, an application dependency file and a DSL data set identification.

Optionally, the basic information includes a DSL data set identification; and the acquiring a domain specific language (DSL) data set for describing an initial configuration information of a target application includes: based on the DSL data set identification in the basic information, acquiring a corresponding DSL data set, in which the acquired DSL data set is configured to describe the initial configuration information of the target application.

According to a second aspect of the embodiments of the present disclosure, there is provided an application packaging device. The device includes: an acquisition unit configured to acquire a domain specific language (DSL) data set for describing an initial configuration information of a target application, the target application including a target application page; a parsing unit configured to parse the DSL data set to obtain a runnable code project including the initial configuration information, in which the runnable code project includes a target page code file for rendering the target application page, and during parsing of the DSL data set, DSL page data for describing the target application page in the DSL data set is populated into the target page code file; and a packaging unit configured to generate a package of the target application based on the runnable code project, in which the generated package includes a DSL parsing module configured to: during a running process, parse the DSL page data populated in the target page code file, and render the target application page based on a parsed information.

Optionally, the DSL parsing module is configured to: during the running process, parse the DSL page data populated in the target page code file, and determine, based on the parsed information, a control in the target application page and an attribute value corresponding to the control; and render the target application page based on the determined control and the attribute value corresponding to the control.

Optionally, the generated package is further configured to: during the running process, update the DSL page data populated in the target page code file; and invoke the DSL parsing module to parse the updated DSL page data, and re-render the target application page based on the parsed information.

Optionally, the parsing unit is configured to: parse the DSL page data for describing the target application page in the DSL data set, and create a page initial code file for the target application page based on a parsing result; and populate the parsed DSL page data into the created page initial code file to obtain the target page code file.

Optionally, the parsing result includes an information for indicating whether the target application page includes a business function module; and the parsing unit is configured to: in a case of determining that the target application page includes the business function module, create different page initial code files respectively for the target application page and the business function module based on the parsing result.

Optionally, in the case of determining that the target application page includes the business function module, the parsing unit is configured to: populate DSL business data for describing the business function module in the parsed DSL page data into a page initial code file created for the business function module, so as to obtain a business code file; populate DSL layout data for describing a page layout in the parsed DSL page data into a page initial code file created for the target application page, so as to obtain a layout code file; and determine the obtained business code file and the obtained layout code file as the target page code file.

Optionally, the packing unit is configured to: provide an editing interface for editing the runnable code project such that the runnable code project is secondarily developed based on a user's operation on the editing interface; and package the secondarily developed runnable code project to obtain the package of the target application.

Optionally, the packing unit is configured to: run the runnable code project to acquire a parameter passing information such that the runnable code project is secondarily developed based on the parameter passing information; and package the secondarily developed runnable code project to obtain the package of the target application.

Optionally, the business code file is used for rendering a corresponding business function module; the page layout includes a rendering position of the business function module in the application page; and the layout code file is used for determining the rendering position of the business function module in the target application page; and before packaging the secondarily developed runnable code project, the packaging unit is further configured to: check, in the target page code file, whether the layout code file includes a rendering position information of the business function module.

Optionally, the initial configuration information includes at least one of a page configuration information, an event binding information, a data binding information, and a component routing information.

Optionally the acquisition unit is configured to: determine a target running platform for the target application and acquire an application project template of the target running platform, in which the parsing unit is configured to: parse the DSL data set, and obtain the runnable code project including the initial configuration information based on a parsed information and the acquired application project template.

Optionally, the acquired application project template includes a DSL parsing module configured to: during a running process, parse the DSL page data populated in any page code file, and render a corresponding application page based on the parsed information.

Optionally, the acquisition unit is configured to: acquire a cross-platform application project template; and configure the acquired cross-platform application project template as the application project template of the target running platform.

Optionally, the acquisition unit is further configured to: configure a basic information of the target application for the acquired application project template.

Optionally, the basic information includes at least one of a target running platform, an application identification, an application package name, an application version number, an application resource file, an application component information, an application dependency file and a DSL data set identification.

Optionally, the basic information includes a DSL data set identification; and the acquisition unit is configured to: acquire a corresponding DSL data set based on the DSL data set identification in the basic information, in which the acquired DSL data set is configured to describe the initial configuration information of the target application.

It should be understood that both the foregoing general descriptions and the following detailed descriptions are exemplary and illustrative only and are not intended to limit the present disclosure.

### BRIEF DESCRIPTION OF THE DRAWINGS

The accompanying drawings incorporated in and constituting a part of the specification illustrate the embodiments consistent with the present disclosure, and are used to explain the principles of the present disclosure together with the specification.

FIG. 1 is a schematic flow diagram showing an application packaging method according to an embodiment of the present disclosure.

FIG. 2 is a schematic structural diagram showing an application packaging device according to an embodiment of the present disclosure.

FIG. 3 is a schematic diagram showing a hardware structure of a computer apparatus for configuring the method according to an embodiment of the present disclosure.

### DETAILED DESCRIPTION OF EMBODIMENTS

Exemplary embodiments will be described in detail here, and the examples thereof are illustrated in the accompanying drawings. When the following descriptions refer to the drawings, unless otherwise indicated, the same numbers in different drawings indicate the same or similar elements. The implementations described in the following exemplary embodiments do not represent all embodiments consistent with the present disclosure. Rather, they are merely examples of devices and methods consistent with some aspects of the present disclosure as detailed in the appended claims.

It should be noted that the user information (including but not limited to user apparatus information, user personal information, etc.) and data (including but not limited to data for analysis, data stored, data displayed, etc.) involved in the embodiments of the present disclosure are all information and data authorized by the user or fully authorized by all parties. Moreover, the collection, use and processing of relevant data need to comply with relevant laws, regulations and standards of relevant countries and regions, and corresponding operation portals are provided for the user to select authorization or rejection.

With the popularization of computer technologies, a user may use services provided by various applications, such as video applications, music applications, social applications, etc.

However, these applications often need to be manually developed by developers throughout the process, and the development efficiency is low.

In order to solve the above problems, the embodiments of the present disclosure disclose an application packaging method.

In this method, an intermediate language file for describing an application in an intermediate language may be acquired, so that the intermediate language file may be automatically parsed into a runnable code project by an apparatus, and then the runnable code project may be packaged to obtain an application package.

The intermediate language is a language that may be parsed into an executable code, such as a custom language easily parsed into an executable code. Specifically, the intermediate language may be well interpretable and convenient for business personnel to view, and specifically, it may be a pseudocode or a Domain Specific Language (DSL).

With this method, the intermediate language file for describing the application may be automatically parsed by the apparatus to generate a runnable code project and obtain an application package, thereby reducing the manual participation of the developers and improving the development efficiency of the developers.

The intermediate language file may be edited by the developers. The intermediate language file may usually be more interpretable than the executable code, thereby facilitating lowering the threshold for the developers.

In addition, a mapping relationship between the intermediate language and the executable code usually needs to be set in advance, so that the intermediate language is automatically parsed by the apparatus to obtain the executable code.

In order to improve the flexibility of application development, an editing interface may be further opened for the executable code project after the executable code project is generated, which may facilitate a further secondary development based on the automatic development of the apparatus.

Optionally, the executable code project generated through automatic parsing by the apparatus may be regarded as an intermediate product, which is then packaged into an application package after the further secondary development.

Since the intermediate product has not been packaged into an unchangeable program, it has a more flexible form, and is adaptable to a variety of business needs.

An application packaging method provided by the embodiments of the present disclosure will be explained in detail below.

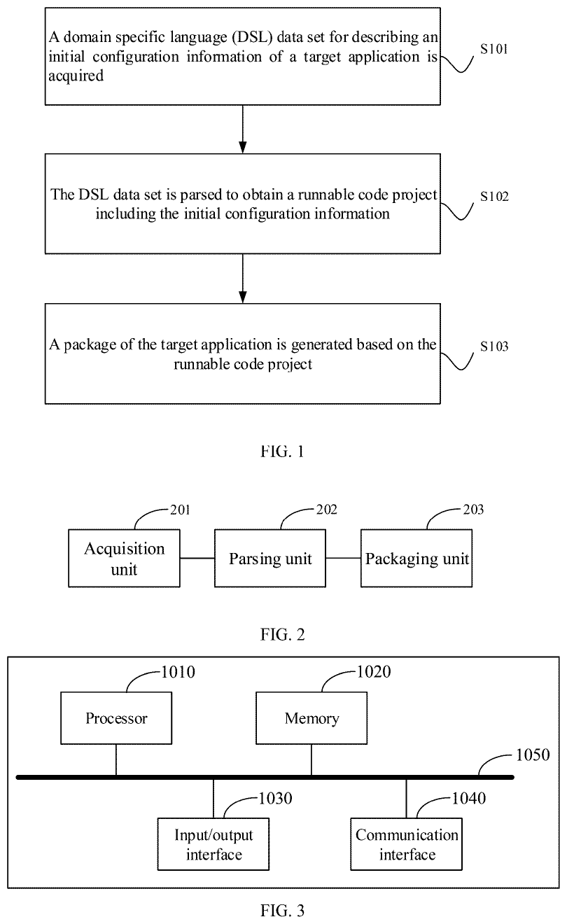

As shown in FIG. 1, FIG. 1 is a schematic flow diagram showing an application packaging method according to an embodiment of the present disclosure.

The embodiments of the present disclosure do not limit an execution subject of the present method flow. Optionally, the execution subject may be any computing apparatus, such as, a terminal side, a server side, or other electronic apparatuses.

Optionally, since application packaging is a part of the development process, the execution subject may be a development side apparatus.

The method may include the following steps.

S101: A domain specific language (DSL) data set for describing an initial configuration information of a target application is acquired.

The target application may include an application page, specifically, it may include a target application page. Specifically, the target application may include one or more application pages, so as to show information to a user and facilitate interaction by the user through the application pages.

The target application specifically may be any application. For the convenience of description, any application that needs to be developed is referred to as the target application.

The target application page specifically may be any application page. It may be understood that reference may be made to the explanation of the target application page for the explanation of any application page in the target application.

The initial configuration information may specifically be related information configured for the target application during the development process before the secondary development. Specifically, it may be a page configuration information, an event binding information, a data binding information and other information in the configuration of the target application.

S102: The DSL data set is parsed to obtain a runnable code project including the initial configuration information.

The runnable code project may include a page code file for rendering an application page. Specifically, it may include a target page code file for rendering a target application page.

The target page code file may specifically be any page code file. For the convenience of description, any page code file is referred to as the target page code file, so as to facilitate a subsequent explanation.

During the parsing of the DSL data set, DSL page data for describing the target application page in the DSL data set may be populated into the target page code file for rendering the target application page.

It may be understood that during the parsing of the DSL data set, a plurality of page code files may be generated, and reference may be made to the explanation of the target page code file for the explanation of each page code file.

S103: A package of the target application is generated based on the runnable code project.

The generated package may include a DSL parsing module, and the DSL parsing module may be used to: during a running process, parse the DSL page data populated in the target page code file, and render the target application page based on a parsed information.

Optionally, the runnable code project may include a programming language and DSL data. The programming languages may be C language, C++, python, etc.

With the above method flow, the DSL data set for describing the target application may be acquired, and the DSL data set may be automatically parsed by the apparatus to generate the runnable code project and obtain the package of the target application, thereby reducing the manual participation of the developers and improving the development efficiency of the developers.

The present method flow does not limit a specific target application. For the convenience of description, an application that needs to be packaged is referred to as the target application.

Moreover, the present method flow does not limit the number of page code files in the runnable code project. For the convenience of description, explanation is made to one of the application pages and a corresponding page code file is referred to as a target page code file. It may be understood that reference may be made to the explanation of the target page code file for other page code files.

Each step is explained in detail below.

I. S101: A domain specific language (DSL) data set for describing an initial configuration information of a target application is acquired.

1) About the DSL data set

The present method flow does not limit the specific form of a Domain Specific Language (DSL) or a specific format of the DSL data set.

For example, for a document writing task, a lightweight markup language (Markdown) may be used as DSL; for a string matching task, a regular expression (RegExp) may be used as DSL; for a work process control task, a dependency detection tool (Make) language or an automation build tool (Gradle) language may be used as DSL; for a data search task, a structured query language (SQL) may be used as DSL; and for a web styling coding task, a cascading style sheets (CSS) language may be used as DSL. The code file obtained by DSL writing is also known as a DSL data set. Accordingly, the specific formats of DSL data sets corresponding to different DSLs will be different. The present disclosure does not limit the specific programming language used by the DSL data set and the format of the DSL data set.

Optionally, the domain specific language (DSL) may include any of a pseudocode, a user-defined language, Chinese, etc. Optionally, the format of the DSL data set may be json format or other formats.

Optionally, the DSL data set may be used as an intermediate language file, which may be easily parsed into an executable code.

Therefore, the language or format of the DSL data set is not limited, as long as the process may parse the DSL data set and obtain the executable code project.

2) The present method flow does not limit the acquiring manner and acquiring source of the DSL data set.

Optionally, the DSL data set may be acquired locally or externally. Specifically, the DSL data set may be a DSL data set issued by the server side or another apparatus, or it may be acquired from another apparatus on the development side.

Optionally, the DSL data set may also be acquired locally. Specifically, the DSL data set may be a pre-downloaded DSL data set, or it may be a DSL data set obtained by accepting the editing of the developer by the development side apparatus.

3) About the initial configuration information of the target application.

The present method flow does not limit the specific form of the initial configuration information of the target application.

Optionally, the initial configuration information includes at least one of a page configuration information, an event binding information, a data binding information, and a component routing information.

The page configuration information may specifically be a control-related information included in the page, for example, the control type and control attribute included in the page.

The event binding information may specifically be an event-related information included in the target application. An event may specifically include a trigger mechanism and a corresponding operation, and the trigger mechanisms in the event may be bound to a control in the page. For example, upon clicking the query button in the page, an interaction event may be triggered to perform a corresponding query operation.

The data binding information may specifically be a data-related information included in the target application. Data may be specifically bound to the control in the page. For example, for a query result of the target application, the query result may be displayed in a bound page table for the convenience of the user to view.

The component routing information may specifically be the component dependencies included in the target application. In the target application, the corresponding functions may be achieved by means of components, and there may be dependencies among components. For example, a query component usually needs to rely on a component that interacts with the back-end database.

4) About the initial configuration process of the target application The present method flow does not limit the configuration manner of the target application during the development process.

The target application usually needs to be designed and configured by the developers, so as to publish or update the target page.

Optionally, the target application may be configured by the developers directly writing the DSL data set, or it may also be configured through a visualization platform.

The visualization platform may be used to configure the initial configuration information of the application based on the interactive operation of the user. The present embodiment does not limit the specific interactive operation and the initial configuration information.

Optionally, the initial configuration information may include at least one of a page configuration information, an event binding information, a data binding information, and a component routing information. Reference may be made to the above text for the specific explanation.

Optionally, the control-related information in the page configuration information may be specifically configured, such as a control layout information, a control size, and a control content. The event binding information and the data binding information in the application may also be configured, such as an inter-page transition event, a control interaction event and intra-page parameter data. Specifically, event binding and data binding may be performed.

Optionally, the interactive operation of the developers may include at least one of a control drag-and-drop operation, an event binding operation, a data binding operation, a configuration operation, and a control resizing operation.

In a specific example, the developers may perform an interactive operation for the visualization platform by first setting the size of a background panel of the whole page, configuring the content of the background panel, specifically, configuring pictures, and then designing the overall layout of the page by dragging and dropping the control and adjusting the position and size event and data.

In the present embodiment, the visualization platform may be used to lower the development threshold of developers, and improve the operation convenience degree for the developers to configure applications.

5) About the generation manner of the DSL data set

The present method flow does not limit the generation manner of the DSL data set.

Optionally, the DSL data set for describing the target page may be edited directly by the developers.

For example, a pseudo code may be used as the DSL data set, and accordingly, the developers may edit a pseudo code for describing the initial configuration information of the target page, as the DSL data set.

Optionally, the initial configuration information of the target application may also be converted into the DSL data set. Specifically, a conversion may be performed based on the configuration information for the target application in the visualization platform.

For example, the developers may configure one application page in the target application through the visualization platform. Specifically, configuration may be performed on attributes such as a control type, a control position and a control size in the application page. Then, the configuration information may be converted into a form of DSL data and added to the DSL data set.

Specifically, the configuration information may be converted into a json form. For example, a button control with a size of 3*5 in the target application page may be converted into a control information in the json form. The specific control type is a button with a size of 3*5.

II. Step S102: The DSL data set is parsed to obtain a runnable code project including the initial configuration information.

The runnable code project may include a page code file for rendering the application page. Optionally, the page code file may specifically be of a Dart format, and the page code file may specifically be a Dart file.

During the parsing of the DSL data set, DSL page data for describing the target application page in the DSL data set may be populated into the target page code file for rendering the target application page.

Optionally, the target page code file may be a target Dart file, which may include an executable code for page rendering, and further may include the populated DSL page data.

The DSL page data may be DSL data for describing the application page in the target application.

The present embodiment does not limit the content in the DSL page data. Optionally, the DSL page data may include information such as a control-related information, an event binding information and a data binding information in the described application page. Accordingly, based on the DSL page data, related information of the application page may be conveniently obtained by parsing for subsequent page rendering.

1. The page code file in the runnable code project will be explained in detail below.

The present method flow does not limit the manner of parsing the DSL data set to obtain a runnable code project, as long as the runnable code project may include the initial configuration information of the target application described by the DSL data set.

For the page code file in the runnable code project, in an optional embodiment, the page information in the DSL data set may be parsed to generate a corresponding page code file for rendering the application page in the target application.

The generated page code file may be added to the runnable code project.

Moreover, because of the need of enabling the page code file to include the corresponding DSL page data, the DSL page data may be populated into the corresponding page code file.

Therefore, optionally, populating the DSL page data for describing the target application page in the DSL data set into the target page code file for rendering the target application page may include: parsing the DSL page data for describing the target application page in the DSL data set, and creating a page initial code file for the target application page based on a parsing result; and populating the parsed DSL page data into the created page initial code file to obtain the target page code file.

In the present embodiment, a page initial code file may be created by parsing the DSL page data for describing the application page in the DSL data set, and then the DSL page data is populated into the created page initial code file to obtain the page code file that may be used for page rendering, thereby improving the efficiency and flexibility of parsing.

The present embodiment does not limit the specific format of the page initial code file, as long as it may be used for page rendering.

Optionally, the page initial code file may include a parsing function and an unassigned page information, so that the DSL page data populated subsequently may be parsed through the parsing function, values may be assigned to the page information, and page rendering may be performed based on the assigned page information.

Optionally, the page initial code file may be blank, and may only include the DSL page data populated subsequently. The target application may invoke the DSL parsing module to parse the DSL page data in the page code file to determine a control in the application page and a corresponding control attribute value, and then render the application page based on the determined control and the corresponding control attribute value.

In other words, the number of the page initial code files may be determined by parsing the DSL page data in the DSL data set. This is convenient for subsequently populating the DSL data, so as to facilitate parsing and page rendering by the DSL parsing module.

Optionally, the page initial code file may be in the form of a dart file, which may be used for page rendering.

Further, during creation of the page initial code file, in order to facilitate the subsequent secondary development, a plurality of page initial code files may be created for a single application page and respectively populated with the DSL data for describing different portions of the application page.

It should be noted that during the process of application development and configuration, some functions may be complicated and may not be automatically parsed directly by the apparatus to generate an executable code for function implementation. Therefore, the functions are usually implemented with the help of subsequent secondary development.

If a single application page corresponds to a single page code file, during the secondary development, a query needs to be performed from the codes of the whole application page.

Moreover, complicated parameter passing is often involved for function implementation, and it is often difficult to quickly determine the parameter passing situation among page-based code files.

For example, in order to implement a certain function in a first page, a certain parameter input in a second page is needed, and the name of this parameter in the codes of the second page needs to be clarified. Therefore, a query needs to be performed from the whole page code file of the second page, which is time-consuming.

For another example, 500 parameters need to be passed between a third page and a fourth page, but only one parameter is needed to implement a certain function in the third page. Correspondingly, a query needs to be performed from 500 parameters, which wastes time and energy.

Therefore, a further function splitting may be performed for a single application page to modularize a function, and a split function module may be separately parsed into one code file.

In other words, a single application page may be parsed into a plurality of code files, which may reduce the amount of codes in a single code file, and each code file has a corresponding function to facilitate query.

Moreover, with the parameter passing among pages, the parameters passed among pages may be distinguished through a plurality of code files.

For example, the first page includes a login function module and a registration function module, and the second page includes a query function module, which is used to query related information of a login user. Therefore, parameters transmitted from the first page to the second page may be divided into parameters transmitted from “a code file corresponding to the login function module” and “a code file corresponding to the registration function module” to the code file corresponding to the second page for the convenience of subsequent query.

For the convenience of description, modules used to implement functions in the application page are described as business function modules, and the business function modules may be used to implement the split functions.

The present embodiment does not limit the splitting manner of the business function module. Optionally, the business function modules in the application page may be determined directly based on the configuration of the developers.

The business function module may be a login function module, a registration function module, a code scanning function module, and the like.

On the one hand, the amount of codes in a single code file is reduced, which is convenient for query. Moreover, a single function module often has a complete function implementation, which is convenient for viewing. On the other hand, parameters passed among pages may be conveniently distinguished, and parameter passing among different function modules may be clarified, which is convenient for query.

Therefore, optionally, the parsing result by parsing the DSL page data includes an information for indicating whether the target application page includes a business function module.

Creating a page initial code file for the target application page based on a parsing result may specifically include: in a case of determining that the target application page includes the business function module, creating different page initial code files respectively for the target application page and the included business function module based on the parsing result. The created page initial code file may be used for rendering the target application page.

Certainly, the application page may include one or more business function modules. Specifically, a page initial code file may be created for each business function module included, or the page initial code file may also be created for some business function modules.

In the present embodiment, a plurality of page initial code files may be created for a single application page, which is convenient for subsequent secondary development and improves development efficiency.

Optionally, in a case that any application page does not include a business function module, i.e., there is no module that needs to be split, a single page initial code file may be directly created. Creating a page initial code file based on a parsing result may include creating a page initial code file for the application page based on the parsing result.

Regarding specifically populating the page initial code file, optionally, in the case of determining that the target application page includes the business function module, the populating the parsed DSL page data into the created page initial code file to obtain the target page code file may include: populating DSL business data for describing the business function module in the parsed DSL page data into a page initial code file created for the business function module, so as to obtain a business code file; populating DSL layout data for describing a page layout in the parsed DSL page data into a page initial code file created for the target application page, so as to obtain a layout code file; and determining the obtained business code file and the obtained layout code file as the target page code file.

The present embodiment does not define the specific content of the page layout. Optionally, the page layout may include a rendering position of a business function module, and may also include related information on controls other than business function modules.

For example, for one application page, one query function module and two buttons need to be deployed. Therefore, the page layout may include the rendering position of the query function module and related information on the two buttons, which may specifically be information such as the rendering position, size and display text of the two buttons.

Correspondingly, the present embodiment does not limit the specific content of the DSL layout data. Optionally, the DSL layout data may include a rendering position of a business function module, and may also include related information on controls other than business function modules.

In order to facilitate understanding, in an optional specific embodiment, a folder may be created for the application page including the business function module, and determined as the target page code file, and then the business code file and the layout code file may be placed in the folder.

Optionally, the layout code file and the business code file may be used for commonly rendering the application page that needs to be rendered in the target page code file. Specifically, the business code file may render the business function module, and the layout code file may render other parts of the application page and integrate the rendered business function module to obtain the final application page.

Specifically, a rendering position of a business function module in the application page may be determined based on the layout code file.

Optionally, the business code file may be used for rendering the corresponding business function module. The page layout may include the rendering position of the business function module in the application page. The layout code file may be used for determining the rendering position of the business function module in the target application page.

The present embodiment does not limit the division of business function modules.

Optionally, the business function module in a page may be specified in the DSL data set.

For example, the DSL business data for describing the business function module in the page may be marked in the DSL data set, or the DSL business data for describing the business function module in the page may be stored independently.

Optionally, the business function module in a page may be configured by the developer.

In a specific example, the target application may specifically be a large-screen display application, which needs to display data statistical analysis results of five parts, so that five business function modules may be configured to respectively render the data statistical analysis results.

For another example, the target application may specifically be an offline fulfillment platform, and a single page may include a plurality of business function modules such as food, take-away, renting and shopping. The implementation logics of various business function modules are completely different, and therefore, business code files may be built separately.

2. About the project template

In an optional embodiment, the runnable code project may be generated by means of an application project template.

Optionally, the above method flow may further include determining a target running platform of the target application and acquiring the application project template of the target running platform. The running platform, may be for example, Android, IOS, and computer end.

The present embodiment neither limits the form of the application project template, nor does it limit the specific target running platform.

Optionally, parsing the DSL data set to obtain the runnable code project including the initial configuration information may include: parsing the DSL data set, and obtaining the runnable code project including the initial configuration information based on the parsed information and the acquired application project template.

In the present embodiment, the generation efficiency of the runnable code project may be improved with the help of the application project template.

Certainly, the present embodiment does not limit how to specifically obtain a runnable code project based on the parsed information and the application project template.

Optionally, the initial configuration information of the target application in the parsed information may be populated into the application project template to obtain the runnable code project.

Optionally, the runnable code project may include a page code file. The page code file may be used for rendering the application page, which may be specifically in the form of a Dart file.

Therefore, optionally, the acquired application project template may include a page template code.

Optionally, obtaining the runnable code project including the initial configuration information based on the parsed information and the acquired application project template may include: determining corresponding page template codes based on an information of any application page in the parsed information, and combining the determined page template codes to obtain a page initial code file; and populating the DSL page data for describing the application page in the DSL data set into the created page initial code file to obtain the page code file.

In the present embodiment, the generation efficiency of the page code file may be improved through the page template code.

The page template code may specifically include a control template code. The corresponding control template code may be determined based on the control type included in the application page in the parsed information.

Subsequently, the control information may be populated into the control template code based on the populated DSL page data to render the corresponding control, thereby rendering the application page.

Optionally, the project template may include a DSL parsing module. The DSL parsing module may be used to, during a running process, parse the DSL page data populated in any page code file, and render the corresponding application page based on a parsed information.

The DSL parsing module in the generated package may be a DSL parsing module provided by and included in the project template. The DSL parsing module may specifically be a cross-platform parsing engine for parsing DSL data. The cross-platform parsing engine may be conveniently adapted to different running platforms, thereby improving the stability of parsing.

In the present embodiment, the page code file may only include the DSL page data, and the DSL parsing module may also be used for parsing and page rendering.

Optionally, in order to acquire the application project template applicable for the target running platform, the cross-platform application project template may be used to reduce the development difficulty.

Optionally, acquiring the application project template of the target running platform may include: acquiring a cross-platform application project template; and configuring the acquired cross-platform application project template as the application project template of the target running platform.

Optionally, in order to facilitate the subsequent program packaging, a basic information of the target application, such as the name and icon of the target application, may be configured for the runnable code project. Specifically, this may be configured by the developers.

Optionally, the above method flow may further include configuring a basic information of the target application for the acquired application project template.

Optionally, the basic information may include at least one of: a target running platform, an application identification, an application package name, an application version number, an application resource file, an application component information, an application dependency file and a DSL data set identification.

The target running platform may be a platform where the target application runs, specifically, it may be Android, IOS, a computer end and the like. The application identification may be an identification for distinguishing different applications. The application package name may be a package body name as a package. The application version number may be used to distinguish different versions of the target application and to distinguish the order of updates.

The application resource file may specifically be a resource that the application needs to invoke in the running process, such as an image, a video and a text.

The application component information may specifically be a component that the application needs to invoke in the running process, such as a database component, a mathematical component and an integral calculation component.

The application dependency file may specifically be a file that the application needs to depend on for running.

The DSL data set identification may be used to determine the DSL data set that needs to be parsed.

Configuring the above basic information may facilitate generation of a standardized package.

Optionally, the DSL data set may be further acquired after the basic information is acquired. Specifically, the DSL data set may be preset to facilitate subsequent selection and acquisition.

Therefore, optionally, the basic information may include the DSL data set identification; and acquiring a domain specific language (DSL) data set for describing an initial configuration information of a target application may include: acquiring a corresponding DSL data set based on the DSL data set identification in the basic information; and the acquired DSL data set is used for describing the initial configuration information of the target application.

3. Page rendering and updating

The present methos flow does not limit the specific manner of implementing page rendering.

Optionally, parsing the DSL page data populated in the target page code file and rendering the target application page based on a parsed information may include: during the running process, parsing the DSL page data populated in the target page code file, and determining, based on the parsed information, a control in the target application page and an attribute value corresponding to the control; and rendering the target application page based on the determined control and the attribute value corresponding to the control.

In the present embodiment, by using the target page code file, the page rendering may be implemented by parsing the DSL page data in the target page code file in real time during the running process, thereby improving the real-time rendering performance. Moreover, since the page rendering is performed by parsing the DSL page data in real time, the page re-rendering may be implemented by subsequently updating the DSL data in the page code file for the running target application package.

It should be noted that the above explanation is aimed at one target page code file in the runnable code project, and it may be understood that reference may be made to the above explanation for any page code file for rendering an application page.

Therefore, optionally, any page code file for rendering an application page in the runnable code project may include DSL page data for describing the rendered application page. In the generated package, the DSL parsing module may be used to, during the running process, parse the DSL page data populated in any page code file and render the corresponding application page based on the parsed information.

The present embodiment does not limit the specific manner of implementing page re-rendering.

For the target application, optionally, the layout or presentation in the page of the target application needs to be updated due to the business change or the version update, and therefore, the application page needs to be re-rendered. Certainly, the layout or presentation in the application page needs to be updated due to the event execution of the local apparatus, for example, the related results need to be listed for presentation during data query, and therefore, the application page needs to be re-rendered.

Optionally, the generated package may also be used to, during the running process, update the DSL page data populated in the target page code file; and invoke the DSL parsing module to parse the updated DSL page data, and re-render the target application page based on the parsed information.

The present embodiment does not limit the specific manner of updating the DSL page data in the page code file.

Optionally, an update may be directly performed. Specifically, new DSL page data transmitted by another apparatus may be received, and then it may be directly updated into the corresponding page code file.

Optionally, the page code file may include an interface code for acquiring a corresponding current DSL page data, so that the interface code may be run and the current DSL page data may be directly acquired for updating.

Optionally, the page code file may include a data identification for acquiring a corresponding current DSL page data, so that based on the data identification, the current DSL page data may be acquired from another apparatus (such as a corresponding server side) for updating.

Optionally, the DSL page data that needs to be updated may also be acquired from the event execution of the local apparatus, and then updated.

S103: A package of the target application is generated based on the runnable code project.

The present method flow does not limit the specific packaging manner.

Before the specific packaging, a secondary development may be performed.

The present method flow does not limit the specific secondary development manner.

Optionally, an editing permission and editing interface of the runnable code project may be opened, so as to receive the operation of the developers from the editing interface and update the runnable code project.

Optionally, generating a package of the target application based on the runnable code project may include: providing an editing interface for editing the runnable code project such that the runnable code project is secondarily developed based on a user's operation on the editing interface; and packaging the secondarily developed runnable code project to obtain the package of the target application.

Optionally, in order to facilitate the secondary development, since during the secondary development, parameters passed in the runnable code project may be used, such as parameters passed among different pages and parameters passed among different function implementations, the executable code project may be directly run, so that the parameter passing information in the current executable code project may be specifically presented, so as to facilitate the secondary development.

For example, the card swiping function of the first page receives the account field “username” passed by the login function of the second page, so that it is convenient to use the “username” field name for a secondary development of the card swiping function.

The present embodiment does not limit the presentation manner of the parameter passing information. Optionally, during the running process of the runnable code project, the log may include related information on parameter passing, so that the parameter passing information, such as parameter names passed among different page code files, may be filtered out from the log.

Optionally, a program may also be set in the runnable code project to capture the parameter passing information, so that the parameter names passed among different files may be captured and then presented to the user, so as to facilitate the secondary development.

Therefore, optionally, generating the package of the target application based on the runnable code project may include: running the runnable code project to acquire the parameter passing information, so as to perform the secondary development for the runnable code project based on the parameter passing information; and packaging the secondarily developed runnable code project to obtain the package of the target application.

The present embodiment does not limit the specific form and content of the parameter passing information.

Optionally, the parameter passing information may include a parameter field, a parameter source and a parameter passing target, thereby facilitating the secondary development.

In the present embodiment, the efficiency of the secondary development may be improved by acquiring the parameter passing information.

In an optional embodiment, since parameter passing is involved, a plurality of code files may be created for a single application page including the business function module, so as to facilitate querying the passed parameters.

Specifically, during the secondary development for a single business function module, the parameter information passed to the business function module, such as a parameter field and a parameter source, may be directly determined conveniently.

However, it should be noted that appearances of some business function modules, such as sizes, shapes, and controls, are not determined until these business function modules are be omitted in the layout code file.

Optionally, the business code file may be used for rendering a corresponding business function module; the page layout may include a rendering position of the business function module in the application page; and the layout code file may be used for determining the rendering position of the business function module in the target application page; and before packaging the secondarily developed runnable code project, it may be checked, in the target page code file, whether the layout code file includes a position information of the business function module corresponding to the business code file.

Optionally, it may specifically be checked in the target page code file that whether the layout code file includes a position information of the business function module corresponding to each business code file.

In the target page code file, if the layout code file does not include a position information of the business function module corresponding to any business code file, a prompt may be issued to continue the secondary development, or a position may be automatically set in the page, such as a position in the page that does not block other controls.

It should be noted that the above explanation is aimed at the target page code file. It may be understood that reference may be made to the above explanation for any page code file.

In the present embodiment, the stability of application development may be improved by checking the relationship between the layout code file and the business code file before packaging.

For the convenience of understanding, the embodiments of the present disclosure further provide a specific application embodiment.

First, a page in the application may be configured through a visual configuration manner. The configuration information of the page may be converted into DSL data to obtain a DSL data set.

After the visual configuration, the DSL data set may be stored, and in addition to the DSL data set, resources such as corresponding pictures may be saved.

Afterwards, in order for a subsequent development, the following steps may be performed.

1. Based on a Flutter cross-platform project template matched with a cross-platform engine framework (the template is embedded with basic routing calls based on iOS/Android/Windows and signaling transmission middleware), a corresponding project template may be output based on a running platform type selected in the visual configuration.

Specifically, the project template may be a project template running on the selected running platform.

2. The output project template is git cloned into Jenkins packaging machine.

3. Jenkins distributes the basic information of the application to the project template. The basic information may include at least one of: a platform type (Android/iOS/Windows/Web) of the application used to determine what information will be packaged and implanted in the future; an application ID (the unique ID of the application, which is used to distinguish it from the content at the version level and above, and belongs to the platform-specific attributes); a package name of the application (the unique identifier of the application listed in the application store); a version number of the application (the currently built version content); resource files, such as startup pictures/icons of the application, including static configuration pictures, which are put under the corresponding directory folder based on the platform attributes; components respectively belonging to Flutter/iOS/Android, which are put into yaml, Podfile and Gradle files based on the platform information and the optional component information; and an ID information of the DSL data set.

4. The DSL data set generated by a visual editor is acquired based on the ID information of the DSL data set.

Based on the page information obtained by the application ID in the shell script, a corresponding Dart file may be generated (a Dart file is actually a template in the project, and the template mainly needs to replace fixed marker-like strings with DSL page data, and a unified CallBack will be performed in the template to receive events passed by the panel).

If the quantity of business function modules included in the page is 0, then a file of XX page Class.dart may be generated directly. If the quantity of business function modules included in the page is not 0, a folder named XX page will be generated, and then XX page Class.dart will be generated inside the folder.

After the Dart file of the page layer is generated, the positions of the lower-level business function modules are determined based on the directory determined in the previous step, and all the business function modules under the XX page are generated in a format like AaPannel.dart based on the obtained business function module names and placed in the folder of this page. with the real DSL content.

According to the above steps, a project template of the intermediate product may be acquired. This project template actually includes DSL data, and the DSL data may be parsed through the code file therein.

The project template includes all dart files. All file directories are planned, the corresponding DSL data is populated, and an entrance for a secondary editing in a corresponding position is also prepared. Moreover, the required components are introduced into the project template through the pub library/CocoaPods library/Marven library, and it may be determined whether to introduce the basic configuration of other scenarios based on business requirements. The intermediate product exists as a project, the source code may be seen, the source code may be edited, and the developers may directly develop it. The difference between the intermediate product and the final product lies in that the final product exists as an installation package, and therefore, the developers may not perform any secondary development and operation, and directly installs it for use; while the intermediate product is secondarily edited and recompiled to generate the final product. Compared with a direct generation of the final product, the intermediate product is more flexible in morphology, which may highly meet the development needs of various business lines.

Corresponding to the above method embodiment, the embodiments of the present disclosure further provide a device embodiment.

As shown in FIG. 2, FIG. 2 is a schematic structural diagram showing an application packaging device according to an embodiment of the present disclosure.

The embodiments of the present disclosure do not limit an execution subject of the present device embodiment. Optionally, the execution subject may be any computing apparatus, such as, a terminal side, a server side, or other electronic apparatuses.

Optionally, since application packaging is a part of the development process, the execution subject may be a development side apparatus.

The device may include the following units.

An acquisition unit 201 is used to acquire a domain specific language (DSL) data set for describing an initial configuration information of a target application, the target application including a target application page.

A parsing unit 202 is used to parse the DSL data set to obtain a runnable code project including the initial configuration information, in which the runnable code project includes a target page code file for rendering the target application page, and during parsing of the DSL data set, DSL page data for describing the target application page in the DSL data set is populated into the target page code file.

A packaging unit 203 is used to generate a package of the target application based on the runnable code project, in which the generated package includes a DSL parsing module configured to: during a running process, parse the DSL page data populated in the target page code file, and render the target application page based on a parsed information.

Optionally, the DSL parsing module is used to: during the running process, parse the DSL page data populated in the target page code file, and determine, based on the parsed information, a control in the target application page and an attribute value corresponding to the control; and render the target application page based on the determined control and the attribute value corresponding to the control.

Optionally, the generated package is further used to: during the running process, update the DSL page data populated in the target page code file; and invoke the DSL parsing module to parse the updated DSL page data, and re-render the target application page based on the parsed information.

Optionally, the parsing unit 202 is used to: parse the DSL page data for describing the target application page in the DSL data set, and create a page initial code file for the target application page based on a parsing result; and populate the parsed DSL page data into the created page initial code file to obtain the target page code file.

Optionally, the parsing result includes an information for indicating whether the target application page includes a business function module; and the parsing unit 202 is used to: in a case of determining that the target application page includes the business function module, create different page initial code files respectively for the target application page and the business function module based on the parsing result.

Optionally, in the case of determining that the target application page includes the business function module, the parsing unit 202 is used to: populate DSL business data for describing the business function module in the parsed DSL page data into a page initial code file created for the business function module, so as to obtain a business code file; populate DSL layout data for describing a page layout in the parsed DSL page data into a page initial code file created for the target application page, so as to obtain a layout code file; and determine the obtained business code file and the obtained layout code file as the target page code file.

Optionally, the packing unit 203 is used to: provide an editing interface for editing the runnable code project such that the runnable code project is secondarily developed based on a user's operation on the editing interface; and package the secondarily developed runnable code project to obtain the package of the target application.

Optionally, the packing unit 203 is used to: run the runnable code project to acquire a parameter passing information such that the runnable code project is secondarily developed based on the parameter passing information; and package the secondarily developed runnable code project to obtain the package of the target application.

Optionally, the business code file is used for rendering a corresponding business function module; the page layout includes a rendering position of the business function module in the application page; and the layout code file is used for determining the rendering position of the business function module in the target application page; and before packaging the secondarily developed runnable code project, the packaging unit 203 is further used to: check, in the target page code file, whether the layout code file includes a rendering position information of the business function module.

Optionally, the initial configuration information includes at least one of a page configuration information, an event binding information, a data binding information, and a component routing information.

Optionally, the acquisition unit 201 is used to: determine a target running platform for the target application and acquire an application project template of the target running platform, in which the parsing unit 202 is used to: parse the DSL data set, and obtain the runnable code project including the initial configuration information based on a parsed information and the acquired application project template.

Optionally the acquired application project template includes a DSL parsing module used to: during a running process, parse the DSL page data populated in any page code file, and render a corresponding application page based on the parsed information.

Optionally, the acquisition unit 201 is used to: acquired a cross-platform application project template; and configure the acquired cross-platform application project template as the application project template of the target running platform.

Optionally, the acquisition unit 201 is further used to: configure a basic information of the target application for the acquired application project template.

Optionally, the basic information includes at least one of a target running platform, an application identification, an application package name, an application version number, an application resource file, an application component information, an application dependency file and a DSL data set identification.

Optionally, the basic information includes a DSL data set identification; and the acquisition unit 201 is used to: based on the DSL data set identification in the basic information, acquire a corresponding DSL data set, in which the acquired DSL data set is used to describe the initial configuration information of the target application.

Reference may be made to the above method embodiments for the detailed explanation of the above device embodiments.

The embodiments of the present disclosure further provide a computer apparatus. The computer apparatus at least includes a memory, a processor and a computer program stored in the memory and runnable on the processor. The processor, when executing the program, implements any one of the above method embodiments.

The embodiments of the present disclosure further provide an electronic apparatus. The electronic apparatus includes at least one processor and a memory in a communication connection with the at least one processor. The memory stores instructions executable by the at least one processor, and the instructions are executed by the at least one processor to enable the at least one processor to execute any one of the above method embodiments.

FIG. 3 is a schematic diagram showing a hardware structure of a computer apparatus for configuring the method according to an embodiment of the present disclosure. The apparatus may include a processor 1010, a memory 1020, an input/output interface 1030, a communication interface 1040 and a bus 1050. The processor 1010, the memory 1020, the input/output interface 1030 and the communication interface 1040 are in a communication connection with one another through the bus 1050 inside the apparatus.

The processor 1010 may be implemented in the form of a general Central Processing Unit (CPU), a microprocessor, an Application Specific Integrated Circuit (ASIC), or one or more integrated circuits to execute related programs, thereby implementing the technical solutions provided by the embodiments of the present disclosure.

The memory 1020 may be implemented in the form of a Read Only Memory (ROM), a Random Access Memory (RAM), a static storage device, or a dynamic storage device. The memory 1020 may store an operating system and other application programs. When the technical solutions provided by the embodiments of the present disclosure are implemented by software or firmware, relevant program codes are stored in the memory 1020, and invoked and executed by the processor 1010.

The input/output interface 1030 is used to connect an input/output module to achieve information input and output. The input/output module may be configured as a component in the apparatus (not shown in the drawings) or may be externally connected to the apparatus to provide corresponding functions. The input apparatus may include a keyboard, a mouse, a touch screen, a microphone, various sensors, etc., and the output apparatus may include a display, a speaker, a vibrator, an indicator light, etc.

The communication interface 1040 is used to connect a communication module (not shown in the drawings) to achieve communication interaction between the present apparatus and other apparatuses. The communication module may achieve communication in a wired manner (such as USB and network cable) or in a wireless manner (such as mobile network, WIFI and Bluetooth).

The bus 1050 includes a path to transfer information among various components of the apparatus, such as the processor 1010, the memory 1020, the input/output interface 1030 and the communication interface 1040.

It should be noted that although the above apparatus only shows the processor 1010, the memory 1020, the input/output interface 1030, the communication interface 1040 and the bus 1050, in the specific implementation process, the apparatus may further include other components necessary for normal operation. In addition, those skilled in the art may understand that the above apparatus may also only include the components necessary to implement the solutions of the embodiments of the present disclosure, without including all the components shown in the drawings.

The embodiments of the present disclosure further provide a computer-readable storage medium, on which a computer program is stored. The program, when executed by a processor, implements any one of the above method embodiments.

The embodiments of the present disclosure further provide a computer-readable storage medium storing a computer program. The computer program, when executed by a processor, implements any one of the above method embodiments.

The computer-readable medium may include permanent and non-permanent or removable and non-removable medium, and may achieve information storage by any method or technology. Information may be a computer-readable instruction, a data structure, a module of a program or other data. Examples of a storage medium for a computer include, but is not limited to, a phase change memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic disk storage or another magnetic storage apparatus or any other non-transmission medium, which may be used to store information accessible to a computing apparatus. According to the definition herein, the computer-readable medium does not include computer-readable transitory media, such as modulated data signals and carrier waves.

From the description of the above implementations, those skilled in the art may clearly understand that the embodiments of the present disclosure may be implemented by means of software and necessary general hardware platforms. Based on such an understanding, the technical solutions of the embodiments of the present disclosure substantially or the portions making contributions may be embodied in the form of a software product. The computer software product may be stored in a storage medium, such as a ROM/RAM, a magnetic disk, or an optical disk, and includes several instructions to cause a computer apparatus (which may be a personal computer, a server, a network device or the like) to execute the methods described in various embodiments or some parts of the embodiments of the present disclosure.

The systems, devices, modules or units set forth in the above embodiments may be specifically implemented by a computer chip or an entity, or by a product with a certain function. A typical implementation apparatus is a computer, and the specific form of the computer may be a personal computer, a laptop computer, a cellular phone, a camera phone, a smart phone, a personal digital assistant, a media player, a navigation device, an email transceiver, a game console, a tablet computer, a wearable device or a combination of any of these apparatuses.

Various embodiments in the present specification are all described in a progressive manner, the same and similar parts among various embodiments may be referred to one another, and each embodiment focuses on the differences from other embodiments. Especially, for the device embodiments, since they are substantially similar to the method embodiments, the description is relatively simple, and reference may be made to parts of the description of the method embodiments for the relevant points. The device embodiments described above are only schematic. The modules described as separate components may or may not be physically separated, and the functions of various modules may be implemented in one or more software and/or hardware during implementation of the solutions of the embodiments of the present disclosure. Some or all of the modules may also be selected according to actual needs to achieve the objectives of the solutions of the embodiments of the present disclosure. Those of ordinary skills in the art may understand and implement them without any creative effort.

The descriptions above are only specific implementations of the embodiments of the present disclosure. It should be pointed out that those of ordinary skills in the art may make several improvements and embellishments without departing from the principle of the embodiments of the present disclosure, and these improvements and embellishment should also be regarded as protection for the embodiments of the present disclosure.

In the present disclosure, the terms “first” and “second” are only used for descriptive purposes and may not be understood as indicating or implying relative importance. The term “plural” refers to two or more, unless otherwise explicitly defined.

Other implementations of the present disclosure will be readily apparent to those skilled in the art after considering the specification and practicing the present disclosure disclosed herein. The present disclosure is intended to cover any variation, use or adaptive modification of the present disclosure, and these variations, uses or adaptive modifications follow the general principles of the present disclosure and include common knowledge or common technical means in the art that are not disclosed in the present disclosure. The specification and embodiments are regarded as exemplary only, and the true scope and spirit of the present disclosure are indicated by the following claims.

It should be understood that the present disclosure is not limited to the precise structure described above and shown in the drawings, and various modifications and changes may be made without departing from the scope thereof. The scope of the present disclosure is defined only by the appended claims.

1. An application packaging method, applied to a development side apparatus, the method comprising:
acquiring a domain specific language (DSL) data set for describing an initial configuration information of a target application, wherein the target application comprises a target application page;
parsing the DSL data set to obtain a runnable code project comprising the initial configuration information, wherein the runnable code project comprises a target page code file for rendering the target application page;
populating, in a process of the parsing the DSL data set, DSL page data for describing the target application page in the DSL data set into the target page code file; and
generating a package of the target application based on the runnable code project,
wherein the generated package comprises a DSL parsing module configured to: during a running process, parse the DSL page data populated in the target page code file, and render the target application page based on a parsed information.

2. The method according to claim 1, wherein parsing the DSL page data populated in the target page code file, and rendering the target application page based on a parsed information comprises: during the running process,
parsing the DSL page data populated in the target page code file;
determining, based on the parsed information, a control in the target application page and an attribute value corresponding to the control; and
rendering the target application page based on the determined control and the attribute value corresponding to the control.

3. The method according to claim 1, wherein the generated package is further configured to: during the running process,
update the DSL page data populated in the target page code file; and
invoke the DSL parsing module to parse the updated DSL page data, and re-render the target application page based on the parsed information.

4. The method according to claim 1, wherein the populating DSL page data for describing the target application page in the DSL data set into the target page code file comprises:
parsing the DSL page data for describing the target application page in the DSL data set, and creating a page initial code file for the target application page based on a parsing result; and
populating the parsed DSL page data into the created page initial code file to obtain the target page code file.

5. The method according to claim 4, wherein the parsing result comprises an information for indicating whether the target application page comprises a business function module; and
wherein the creating a page initial code file for the target application page based on a parsing result comprises:
in a case of determining that the target application page comprises the business function module, creating different page initial code files respectively for the target application page and the business function module based on the parsing result.

6. The method according to claim 5, wherein in the case of determining that the target application page comprises the business function module, the populating the parsed DSL page data into the created page initial code file to obtain the target page code file comprises:
populating DSL business data for describing the business function module in the parsed DSL page data into a page initial code file created for the business function module, so as to obtain a business code file;
populating DSL layout data for describing a page layout in the parsed DSL page data into a page initial code file created for the target application page, so as to obtain a layout code file; and
determining the obtained business code file and the obtained layout code file as the target page code file.

7. The method according to claim 6, wherein the generating a package of the target application based on the runnable code project comprises:
providing an editing interface for editing the runnable code project such that the runnable code project is secondarily developed based on a user's operation on the editing interface; and
packaging the secondarily developed runnable code project to obtain the package of the target application.

8. The method according to claim 6, wherein the generating a package of the target application based on the runnable code project comprises:
running the runnable code project to obtain a parameter passing information such that the runnable code project is secondarily developed based on the parameter passing information; and
packaging the secondarily developed runnable code project to obtain the package of the target application.

9. The method according to claim 7, wherein the business code file is configured to render a corresponding business function module; the page layout comprises a rendering position of the business function module in the application page; and the layout code file is configured to determine a rendering position of the business function module in the target application page; and
wherein before packaging the secondarily developed runnable code project, the method further comprises:
checking, in the target page code file, whether the layout code file comprises a rendering position information of the business function module.

10. The method according to claim 1, wherein the initial configuration information comprises at least one of a page configuration information, an event binding information, a data binding information, and a component routing information.

11. The method according to claim 1, further comprising: determining a target running platform for the target application and acquiring an application project template of the target running platform,
wherein the parsing the DSL data set to obtain a runnable code project comprising the initial configuration information comprises:
parsing the DSL data set, and obtaining the runnable code project comprising the initial configuration information based on a parsed information and the acquired application project template.

12. The method according to claim 11, wherein the acquired application project template comprises the DSL parsing module,
wherein the DSL parsing module is configured to: during the running process, parse the DSL page data populated in any page code file, and render a corresponding application page based on the parsed information.

13. The method according to claim 11, wherein the acquiring an application project template of the target running platform comprises:
acquiring a cross-platform application project template; and
configuring the acquired cross-platform application project template as the application project template of the target running platform.

14. The method according to claim 11, further comprising: configuring a basic information of the target application for the acquired application project template.

15. The method according to claim 14, wherein the basic information comprises at least one of a target running platform, an application identification, an application package name, an application version number, an application resource file, an application component information, an application dependency file and a DSL data set identification.

16. The method according to claim 14, wherein the basic information comprises a DSL data set identification; and
wherein the acquiring a domain specific language (DSL) data set for describing an initial configuration information of a target application comprises:
acquiring, based on the DSL data set identification in the basic information, a corresponding DSL data set, wherein the acquired DSL data set is configured to describe the initial configuration information of the target application.

17. (canceled)

18. An electronic apparatus, comprising:
at least one processor; and
a memory in a communication connection with the at least one processor;
wherein the memory stores instructions executable by the at least one processor, and the instructions, when executed by the at least one processor, cause the at least one processor to execute the method according to claim 1.

19. A computer-readable storage medium storing a computer program, wherein the computer program, when executed by a processor, implements the method according to claim 1.

20. The method according to claim 8, wherein the business code file is configured to render a corresponding business function module; the page layout comprises a rendering position of the business function module in the application page; and the layout code file is configured to determine a rendering position of the business function module in the target application page; and
wherein before packaging the secondarily developed runnable code project, the method further comprises:
checking, in the target page code file, whether the layout code file comprises a rendering position information of the business function module.

21. The electronic apparatus according to claim 18, wherein the at least one processor is further configured to: during the running process,
parse the DSL page data populated in the target page code file;
determine, based on the parsed information, a control in the target application page and an attribute value corresponding to the control; and
render the target application page based on the determined control and the attribute value corresponding to the control.
